(19) United States
(12) Patent Application Publication
(10) Pub. No.: US 2021/0156881 A1
(43) Pub. Date: May 27, 2021

(54) DYNAMIC MACHINE VISION SENSOR (DMVS) THAT PERFORMS INTEGRATED 3D TRACKING

(71) Applicant: FARO Technologies, Inc., Lake Mary, FL (US)

(72) Inventors: Oliver Zweigle, Stuttgart (DE); Michael Müller, Stuttgart (DE); Mark Brenner, Asperg (DE); Rasmus Debitsch, Fellbach (DE); Gerrit Hillebrand, Waiblingen (DE); Maxim Muschinski, Stuttgart (DE)

(21) Appl. No.: 17/070,134

(22) Filed: Oct. 14, 2020

Related U.S. Application Data
(60) Provisional application No. 62/940,317, filed on Nov. 26, 2019.

(51) Int. Cl. G01P 3/38; G01B 11/00

(52) U.S. Cl. CPC G01P 3/38; G01B 11/002

(57) ABSTRACT

Provided are embodiments for a device and method for measuring three-dimensional (3D) coordinates. Embodiments include a projector having a projector optical axis on a first plane, the projector operable to project a collection of laser beams on a surface of an object, and a first camera having a first-camera optical axis on the first plane, the first camera operable to capture a first image of the collection of laser beams on the surface of the object. Embodiments also include one or more processors, the one or more processors are operable to generate a first distance profile for the object using a first laser beam of the collection of laser beams and generate a second distance profile for the object using a second laser beam of the collection of laser beams, estimate the velocity of the object based on the first and second distance profile, and provide the estimated velocity.

This application claims the benefit of U.S. Patent Application Ser. No. 62/940,317 filed Nov. 26, 2019, which is incorporated herein by reference in its entirety.

### BACKGROUND

The subject matter disclosed herein relates to a triangulation scanner. The triangulation scanner projects uncoded spots onto an object and in response determines three-dimensional (3D) coordinates of points on the object.

Triangulation scanners generally include at least one projector and at least two cameras, the projector and camera separated by a baseline distance. Such scanners use a triangulation calculation to determine 3D coordinates of points on an object based at least in part on the projected pattern of light and the captured camera image. One category of triangulation scanner, referred to herein as a single-shot scanner, obtains 3D coordinates of the object points based on a single projected pattern of light. Another category of triangulation scanner, referred to herein as a sequential scanner, obtains 3D coordinates of the object points based on a sequence of projected patterns from a stationary projector onto the object.

In the case of a single-shot triangulation scanner, the triangulation calculation is based at least in part on a determined correspondence among elements in each of two patterns. The two patterns may include a pattern projected by the projector and a pattern captured by the camera. Alternatively, the two patterns may include a first pattern captured by a first camera and a second pattern captured by a second camera. In either case, the determination of 3D coordinates by the triangulation calculation provides that a correspondence be determined between pattern elements in each of the two patterns. In most cases, the correspondence is obtained by matching pattern elements in the projected or captured pattern. An alternative approach is described in U.S. Pat. No. 9,599,455 ('455) to Heidemann, et al., the contents of which are incorporated by reference herein. In this approach, the correspondence is determined, not by matching pattern elements, but by identifying spots (e.g. points or circles of light) at the intersection of epipolar lines from two cameras and a projector or from two projectors and a camera. In an embodiment, supplementary 2D camera images may further be used to register multiple collected point clouds together in a common frame of reference. For the system described in Patent '455, the three camera and projector elements are arranged in a triangle, which enables the intersection of the epipolar lines.

In some cases, it is desirable to make the triangulation scanner more compact than is possible in the triangular arrangement of projector and camera elements. Accordingly, while existing triangulation systems are suitable for their intended purpose, the need for improvement remains, particularly in providing a compact triangulation scanner that projects uncoded spots to determine three-dimensional (3D) coordinates of points on the object.

### BRIEF DESCRIPTION

According to another aspect of the disclosure, a device for measuring three-dimensional (3D) coordinates is provided. The device also includes a projector having a projector optical axis on a first plane, the projector operable to project a collection of laser beams on a surface of an object; a first camera having a first-camera optical axis on the first plane, the first camera operable to capture a first image of the collection of laser beams on the surface of the object; one or more processors, wherein the one or more processors are operable to: generate a first distance profile for the object using a first laser beam of the collection of laser beams and generate a second distance profile for the object using a second laser beam of the collection of laser beams; estimate the velocity of the object based on the first distance profile and the second distance profile; and provide the estimated velocity.

In accordance with one or more embodiments, or in the alternative, the one or more processors are further operable to perform a shift analysis using the first distance profile and the second distance profile.

In accordance with one or more embodiments, or in the alternative, the one or more processors are further operable to determine a time-shift between the first distance profile and the second distance profile by performing a comparison of the first distance profile and the second distance profile.

In accordance with one or more embodiments, or in the alternative, the one or more processors are operable to filter laser beams of the collection of laser beams; and assign laser beams of the collection of laser beams to the object.

In accordance with one or more embodiments, or in the alternative, filtering of the laser beams is performed based on at least one of a direction or a similarity in the generated profiles laser beams of the collection of laser beams.

In accordance with one or more embodiments, or in the alternative, the one or more processors are operable to determine a set of time-shifts for the object using a plurality of laser beam pairs of the collection of laser beams.

In accordance with one or more embodiments, or in the alternative, estimating the velocity is performed by averaging the set of time-shifts for the object.

In accordance with one or more embodiments, or in the alternative, a profile is generated by obtaining 3D points of the object, calculating a distance of the 3D points between each laser beam, and using the distance and timing information to estimate the velocity of the object.

In accordance with one or more embodiments, or in the alternative, the one or more processors are further operable to receive input velocity information associated with a device that moves the object; and compare the estimated velocity of the object to the input velocity information.

In accordance with one or more embodiments, or in the alternative, the input velocity information is used and determined from at least one of time stamp information or position information of the device that moves the object, wherein the device is at least one of a mover or a conveyor belt.

According to another aspect of the disclosure, a method for measuring three-dimensional (3D) coordinates is provided. The method includes projecting, with a projector, a collection of laser beams on a surface of an object; capturing, with a camera, a first image of the collection of laser beams on the surface of the object; generating a first distance profile for the object using a first laser beam of the collection of laser beams and generating a second distance profile for the object using a second laser beam of the collection of laser beams; estimating, using one or more processors, a velocity of the object based at least in part on the first distance profile and the second distance profile; and providing, using the one or more processors, the estimated velocity of the object.

In accordance with one or more embodiments, or in the alternative, a shift analysis is performed using the first distance profile and the second distance profile.

In accordance with one or more embodiments, or in the alternative, a time-shift analysis is performed between the first distance profile and the second distance profile by performing a comparison of the first profile and the second profile.

In accordance with one or more embodiments, or in the alternative, the laser beams of the collection of laser beams are filtered; and the laser beams of the collection of laser beams are assigned to the object.

In accordance with one or more embodiments, or in the alternative, laser beams are filtered based on at least one of a direction or a similarity in the generated distance profiles laser beams of the collection of laser beams.

In accordance with one or more embodiments, or in the alternative, a set of time-shifts are determined for the object using a plurality of laser beam pairs of the collection of laser beams.

In accordance with one or more embodiments, or in the alternative, the velocity is estimated by averaging the set of time-shifts for the object using the plurality of laser beam pairs.

In accordance with one or more embodiments, or in the alternative, a distance profile is generated by obtaining 3D points of the object, calculating a distance of the 3D points between each laser beam, and using the distance and timing information to estimate the velocity of the object.

In accordance with one or more embodiments, or in the alternative, input information associated with a device that moves the object is received, wherein the input information includes at least one of velocity information, time stamp information, or position information of the device that moves the object; and the estimated velocity of the object to the input information is compared.

In accordance with one or more embodiments, or in the alternative, a conveyor system moving the object to a configured velocity is calibrated.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIGS. 1A, 1B, 1C, 1D, 1E are isometric, partial isometric, partial top, partial front, and second partial top views, respectively, of a triangulation scanner according to an embodiment of the present disclosure;

FIG. 2A is a schematic view of a triangulation scanner having a projector, a first camera, and a second camera according to an embodiment of the present disclosure;

FIG. 2B is a schematic representation of a triangulation scanner having a projector that projects an uncoded pattern of uncoded spots, received by a first camera, and a second camera according to an embodiment of the present disclosure;

FIG. 2C is an example of an uncoded pattern of uncoded spots according to an embodiment of the present disclosure;

FIG. 2D is a representation of one mathematical method that might be used to determine a nearness of intersection of three lines according to an embodiment of the present disclosure;

FIG. 2E is a list of elements in a method for determining 3D coordinates of an object according to an embodiment of the present disclosure;

FIG. 3 is an isometric view of a triangulation scanner having a projector and two cameras arranged in a triangle according to an embodiment of the present disclosure;

FIG. 4 is a schematic illustration of intersecting epipolar lines in epipolar planes for a combination of projectors and cameras according to an embodiment of the present disclosure;

FIGS. 5A, 5B, 5C, 5D, 5E are schematic diagrams illustrating different types of projectors according to embodiments of the present disclosure;

FIG. 6A is an isometric view of a triangulation scanner having two projectors and one camera according to an embodiment of the present disclosure;

FIG. 6B is an isometric view of a triangulation scanner having three cameras and one projector according to an embodiment of the present disclosure;

FIG. 6C is an isometric view of a triangulation scanner having one projector and two cameras and further including a camera to assist in registration or colorization according to an embodiment of the present disclosure;

FIG. 7A illustrates a triangulation scanner used to measure an object moving on a conveyor belt according to an embodiment of the present disclosure;

FIG. 7B illustrates a triangulation scanner moved by a robot end effector, according to an embodiment of the present disclosure;

FIG. 8 illustrates a triangulation scanner operating as a light barrier according to an embodiment of the present disclosure;

FIG. 9 illustrates an example distance profile generated using the triangulation scanner as a light barrier; and

FIG. 10 illustrates a flowchart of a method for performing the tracking of an object using the triangulation scanner.

The detailed description explains embodiments of the disclosure, together with advantages and features, by way of example with reference to the drawings.

### DETAILED DESCRIPTION

In today's environment, 3D scanners are used to perform a variety of measurements for different types of architecture, spaces, and objects. In some embodiments, the 3D scanners can obtain scan data and measurements for moving objects. For example, an object may be moved along a conveyor and scanned by the 3D scanner. However, in order to calculate the speed of the object, additional equipment is generally required to supplement the 3D scanner. This increases the cost and complexity of the system. Also, the size of the 3D scanner or 3D scanning system may be increased to accommodate the additional equipment. The position information obtained by the external equipment may be needed to stitch or join the 3D frames together during the registration process. Systems, for example, in a production environment, may not want to connect to the external position system to obtain the speed data of the object.

The techniques described herein operate the scanning device as a light barrier or curtain to track the movement of an object through its field of view. The projection or scanning device uses a diffractive optical element (DOE) which can emit a plurality of beams. In some embodiments, about 11,665 laser beams can be used. Because the projection and/or scanning device is used as a light barrier, each beam of the light barrier can be used to generate a distance profile of the object as it travels through its field of view. The distance profile of neighboring beams can be cross-correlated to determine the distance the object has traveled between the beams over an identified period can be used to calculate the speed of the object. In some embodiments, various filtering techniques and optimization techniques, as described below, can be used to increase the accuracy of the estimation of the object's velocity.

Embodiments of the present disclosure provide advantages in enabling 3D measurements to be obtained using a relatively compact, low-cost, and accurate triangulation scanner, also referred to herein as a 3D imager or 3D scanner. It further provides advantages in enabling rapid registration, extracting of six degree-of-freedom pose information, and control of robotic mechanisms. Other embodiments enable further improvements through combined used of scanning technologies with laser trackers or articulated arm coordinate measuring machines.

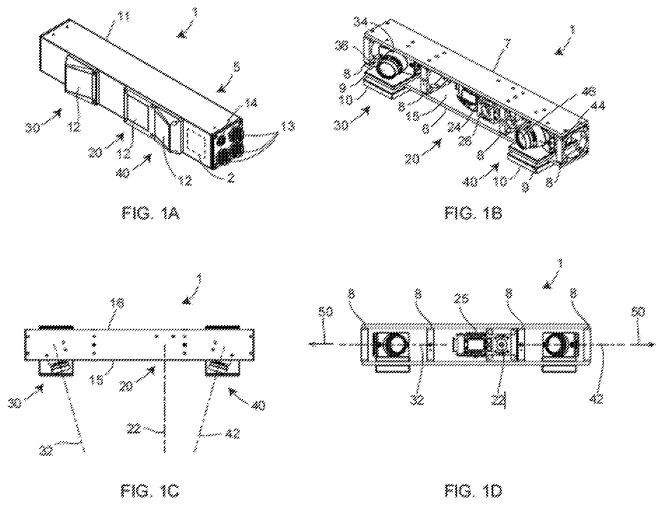

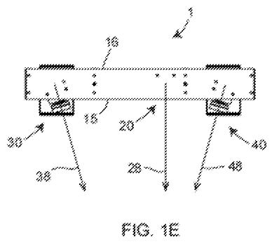

In an embodiment of the present disclosure illustrated in FIGS. 1A, 1B, 1C, 1D, a triangulation scanner 1 includes a body 5, a projector 20, a first camera 30, and a second camera 40. In an embodiment, the projector optical axis 22 of the projector 20, the first-camera optical axis 32 of the first camera 30, and the second-camera optical axis 42 of the second camera 40 all lie on a common plane 50, as shown in FIGS. 1C, 1D. In some embodiments, an optical axis passes through a center of symmetry of an optical system, which might be a projector or a camera, for example. For example, an optical axis may pass through a center of curvature of lens surfaces or mirror surfaces in an optical system. The common plane 50, also referred to as a first plane 50, extends perpendicular into and out of the paper in FIG. 1D.

In an embodiment, the body 5 includes a bottom support structure 6, a top support structure 7, spacers 8, camera mounting plates 9, bottom mounts 10, dress cover 11, windows 12 for the projector and cameras, Ethernet connectors 13, and GPIO connector 14. In addition, the body includes a front side 15 and a back side 16. In an embodiment, the bottom support structure 6 and the top support structure 7 are flat plates made of carbon-fiber composite material. In an embodiment, the carbon-fiber composite material has a low coefficient of thermal expansion (CTE). In an embodiment, the spacers 8 are made of aluminum and are sized to provide a common separation between the bottom support structure 6 and the top support structure 7.

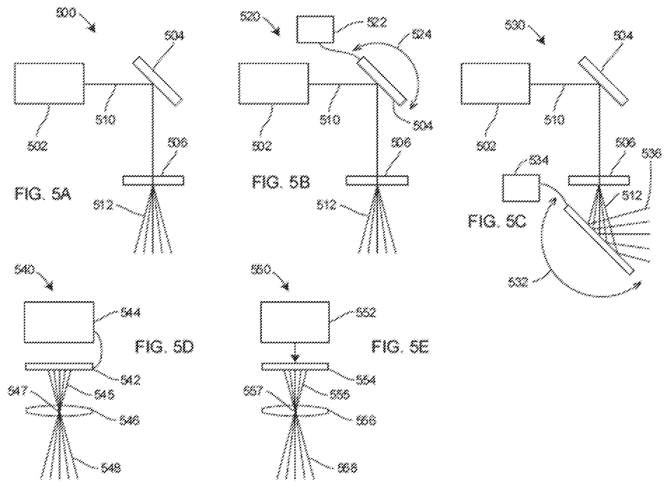

In an embodiment, the projector 20 includes a projector body 24 and a projector front surface 26. In an embodiment, the projector 20 includes a light source 25 that attaches to the projector body 24 that includes a turning mirror and a DOE, as explained herein below with respect to FIGS. 5A, 5B, 5C. The light source 25 may be a laser, a superluminescent diode, or a partially coherent LED, for example. In an embodiment, the DOE produces an array of spots arranged in a regular pattern. In an embodiment, the projector 20 emits light at a near-infrared wavelength.

In an embodiment, the first camera 30 includes a first-camera body 34 and a first-camera front surface 36. In an embodiment, the first camera includes a lens, a photosensitive array, and camera electronics. The first camera 30 forms on the photosensitive array a first image of the uncoded spots projected onto an object by the projector 20. In an embodiment, the first camera responds to near-infrared light.

In an embodiment, the second camera 40 includes a second-camera body 44 and a second-camera front surface 46. In an embodiment, the second camera includes a lens, a photosensitive array, and camera electronics. The second camera 40 forms a second image of the uncoded spots projected onto an object by the projector 20. In an embodiment, the second camera responds to light in the near-infrared spectrum. In an embodiment, a processor 2 is used to determine 3D coordinates of points on an object according to methods described herein below. The processor 2 may be included inside the body 5 or may be external to the body. In further embodiments, more than one processor is used. In still further embodiments, the processor 2 may be remotely located from the triangulation scanner.

FIG. 1E is a top view of the triangulation scanner 1. A projector ray 28 extends along the projector optical axis from the body of the projector 24 through the projector front surface 26. In doing so, the projector ray 28 passes through the front side 15. A first-camera ray 38 extends along the first-camera optical axis 32 from the body of the first camera 34 through the first-camera front surface 36. In doing so, the front-camera ray 38 passes through the front side 15. A second-camera ray 48 extends along the second-camera optical axis 42 from the body of the second camera 44 through the second-camera front surface 46. In doing so, the second-camera ray 48 passes through the front side 15.

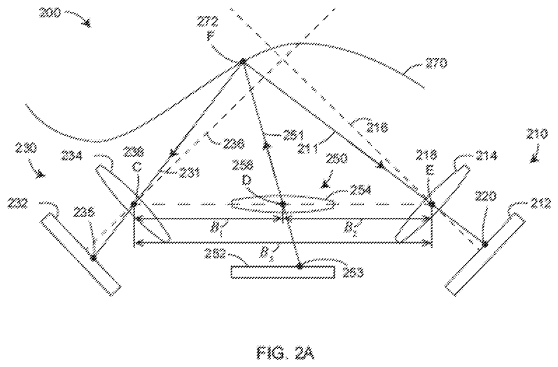

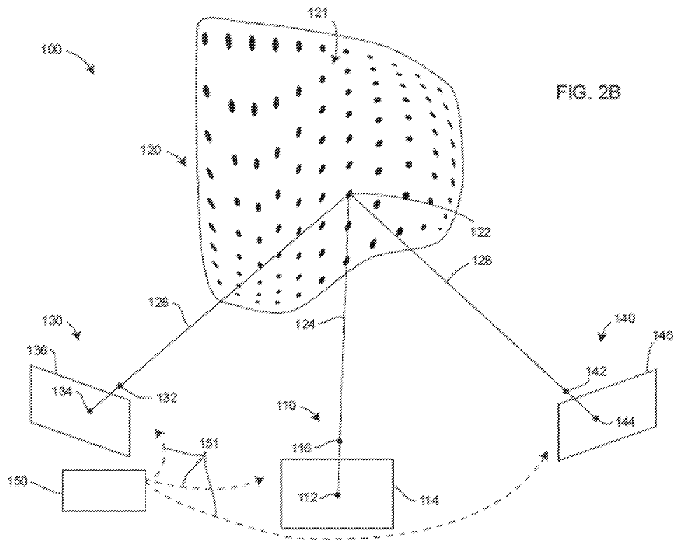

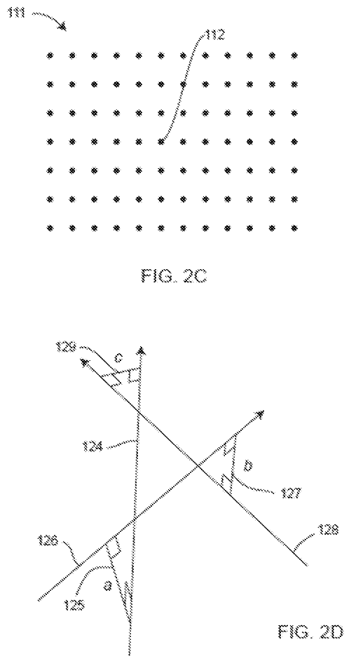

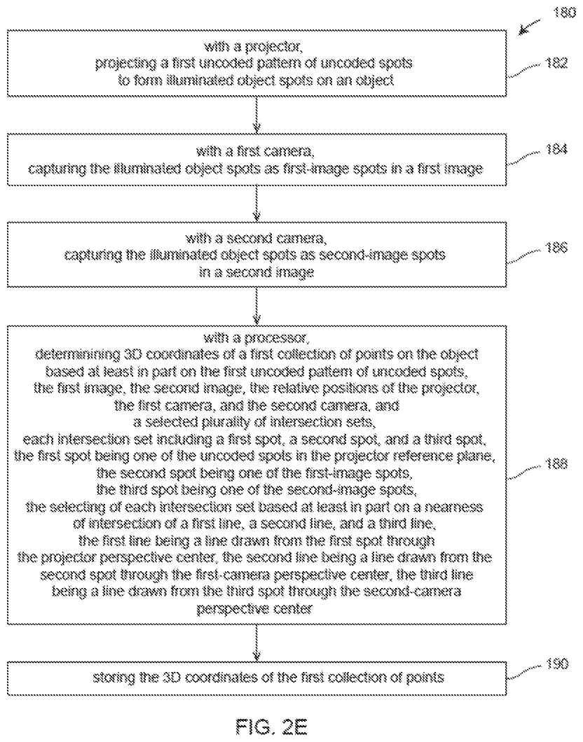

FIGS. 2A-2D show elements of a triangulation scanner 200 that might, for example, be the triangulation scanner 1 shown in FIGS. 1A, 1B, 1C, 1D, 1E. In an embodiment, the triangulation scanner 200 includes a projector 250, a first camera 210, and a second camera 230. In an embodiment, the projector 250 creates a pattern of light on a pattern generator plane 252. An exemplary corrected point 253 on the pattern projects a ray of light 251 through the perspective center 258 (point D) of the lens 254 onto an object surface 270 at a point 272 (point F). The point 272 is imaged by the first camera 210 by receiving a ray of light from the point 272 through the perspective center 218 (point E) of the lens 214 onto the surface of a photosensitive array 212 of the camera as a corrected point 220. The point 220 is corrected in the read-out data by applying a correction value to remove the effects of lens aberrations. The point 272 is likewise imaged by the second camera 230 by receiving a ray of light from the point 272 through the perspective center 238 (point C) of the lens 234 onto the surface of the photosensitive array 232 of the second camera as a corrected point 235. It should be understood that as used herein any reference to a lens includes any type of lens system whether a single lens or multiple lens elements, including an aperture within the lens system. It should be understood that any reference to a projector in this document refers not only to a system projecting with a lens or lens system an image plane to an object plane. The projector does not necessarily have a physical pattern-generating plane 252 but may have any other set of elements that generate a pattern. For example, in a projector having a DOE, the diverging spots of light may be traced backward to obtain a perspective center for the projector and also to obtain a reference projector plane that appears to generate the pattern. In most cases, the projectors described herein propagate uncoded spots of light in an uncoded pattern. However, a projector may further be operable to project coded spots of light, to project in a coded pattern, or to project coded spots of light in a coded pattern. In other words, in some aspects of the present disclosure, the projector is at least operable to project uncoded spots in an uncoded pattern but may in addition project in other coded elements and coded patterns.

In an embodiment where the triangulation scanner 200 of FIGS. 2A-2D is a single-shot scanner that determines 3D coordinates based on a single projection of a projection pattern and a single image captured by each of the two cameras, then a correspondence between the projector point 253, the image point 220, and the image point 235 may be obtained by matching a coded pattern projected by the projector 250 and received by the two cameras 210, 230. Alternatively, the coded pattern may be matched for two of the three elements—for example, the two cameras 210, 230 or for the projector 250 and one of the two cameras 210 or 230. This is possible in a single-shot triangulation scanner because of coding in the projected elements or in the projected pattern or both.

After a correspondence is determined among the projected elements, a triangulation calculation is performed to determine 3D coordinates of the projected element on an object. For FIGS. 2A-2D, the elements are uncoded spots projected in an uncoded pattern. In an embodiment, a triangulation calculation is performed based on selection of a spot for which correspondence has been obtained on each of two cameras. In this embodiment, the relative position and orientation of the two cameras is used. For example, the baseline distance B3 between the perspective centers 218 and 238 is used to perform a triangulation calculation based on the first image of the first camera 210 and on the second image of the second camera 230. Likewise, the baseline Bi is used to perform a triangulation calculation based on the projected pattern of the projector 250 and on the second image of the second camera 230. Similarly, the baseline B2 is used to perform a triangulation calculation based on the projected pattern of the projector 250 and on the first image of the first camera 210. In an embodiment of the present disclosure, the correspondence is determined based at least on an uncoded pattern of uncoded elements projected by the projector, a first image of the uncoded pattern captured by the first camera, and a second image of the uncoded pattern captured by the second camera. In an embodiment, the correspondence is further based at least in part on a position of the projector, the first camera, and the second camera. In a further embodiment, the correspondence is further based at least in part on an orientation of the projector, the first camera, and the second camera.

The term “uncoded element” or “uncoded spot” as used herein refers to a projected or imaged element that includes no internal structure that enables it to be distinguished from other uncoded elements that are projected or imaged. The term “uncoded pattern” as used herein refers to a pattern in which information is not encoded in the relative positions of projected or imaged elements. For example, one method for encoding information into a projected pattern is to project a quasi-random pattern of “dots.” Such a quasi-random pattern contains information that may be used to establish correspondence among points and hence is not an example of an uncoded pattern. An example of an uncoded pattern is a rectilinear pattern of projected pattern elements.

In an embodiment, uncoded spots are projected in an uncoded pattern as illustrated in the scanner system 100 of FIG. 2B. In an embodiment, the scanner system 100 includes a projector 110, a first camera 130, a second camera 140, and a processor 150. The projector projects an uncoded pattern of uncoded spots off a projector reference plane 114. In an embodiment illustrated in FIGS. 2B and 2C, the uncoded pattern of uncoded spots is a rectilinear array 111 of circular spots that form illuminated object spots 121 on the object 120. In an embodiment, the rectilinear array of spots 111 arriving at the object 120 is modified or distorted into the pattern of illuminated object spots 121 according to the characteristics of the object 120. An exemplary uncoded spot 112 from within the projected rectilinear array 111 is projected onto the object 120 as a spot 122. The direction from the projector spot 112 to the illuminated object spot 122 may be found by drawing a straight line 124 from the projector spot 112 on the reference plane 114 through the projector perspective center 116. The location of the projector perspective center 116 is determined by the characteristics of the projector optical system.

In an embodiment, the illuminated object spot 122 produces a first image spot 134 on the first image plane 136 of the first camera 130. The direction from the first image spot to the illuminated object spot 122 may be found by drawing a straight line 126 from the first image spot 134 through the first camera perspective center 132. The location of the first camera perspective center 132 is determined by the characteristics of the first camera optical system.

In an embodiment, the illuminated object spot 122 produces a second image spot 144 on the second image plane 146 of the second camera 140. The direction from the second image spot 144 to the illuminated object spot 122 may be found by drawing a straight line 126 from the second image spot 144 through the second camera perspective center 142. The location of the second camera perspective center 142 is determined by the characteristics of the second camera optical system.

In an embodiment, a processor 150 is in communication with the projector 110, the first camera 130, and the second camera 140. Either wired or wireless channels 151 may be used to establish connection among the processor 150, the projector 110, the first camera 130, and the second camera 140. The processor may include a single processing unit or multiple processing units and may include components such as microprocessors, field programmable gate arrays (FPGAs), digital signal processors (DSPs), and other electrical components. The processor may be local to a scanner system that includes the projector, first camera, and second camera, or it may be distributed and may include networked processors. The term processor encompasses any type of computational electronics and may include memory storage elements.

FIG. 2E shows elements of a method 180 for determining 3D coordinates of points on an object. An element 182 includes projecting, with a projector, a first uncoded pattern of uncoded spots to form illuminated object spots on an object. FIGS. 2B, 2C illustrate this element 182 using an embodiment 100 in which a projector 110 projects a first uncoded pattern of uncoded spots 111 to form illuminated object spots 121 on an object 120.

A method element 184 includes capturing with a first camera the illuminated object spots as first-image spots in a first image. This element is illustrated in FIG. 2B using an embodiment in which a first camera 130 captures illuminated object spots 121, including the first-image spot 134, which is an image of the illuminated object spot 122. A method element 186 includes capturing with a second camera the illuminated object spots as second-image spots in a second image. This element is illustrated in FIG. 2B using an embodiment in which a second camera 140 captures illuminated object spots 121, including the second-image spot 144, which is an image of the illuminated object spot 122.

A first aspect of method element 188 includes determining with a processor 3D coordinates of a first collection of points on the object based at least in part on the first uncoded pattern of uncoded spots, the first image, the second image, the relative positions of the projector, the first camera, and the second camera, and a selected plurality of intersection sets. This aspect of the element 188 is illustrated in FIGS. 2B, 2C using an embodiment in which the processor 150 determines the 3D coordinates of a first collection of points corresponding to object spots 121 on the object 120 based at least in the first uncoded pattern of uncoded spots 111, the first image 136, the second image 146, the relative positions of the projector 110, the first camera 130, and the second camera 140, and a selected plurality of intersection sets. An example from FIG. 2B of an intersection set is the set that includes the points 112, 134, and 144. Any two of these three points may be used to perform a triangulation calculation to obtain 3D coordinates of the illuminated object spot 122 as discussed herein above in reference to FIGS. 2A, 2B.

A second aspect of the method element 188 includes selecting with the processor a plurality of intersection sets, each intersection set including a first spot, a second spot, and a third spot, the first spot being one of the uncoded spots in the projector reference plane, the second spot being one of the first-image spots, the third spot being one of the second-image spots, the selecting of each intersection set based at least in part on the nearness of intersection of a first line, a second line, and a third line, the first line being a line drawn from the first spot through the projector perspective center, the second line being a line drawn from the second spot through the first-camera perspective center, the third line being a line drawn from the third spot through the second-camera perspective center. This aspect of the element 188 is illustrated in FIG. 2B using an embodiment in which one intersection set includes the first spot 112, the second spot 134, and the third spot 144. In this embodiment, the first line is the line 124, the second line is the line 126, and the third line is the line 128. The first line 124 is drawn from the uncoded spot 112 in the projector reference plane 114 through the projector perspective center 116. The second line 126 is drawn from the first-image spot 134 through the first-camera perspective center 132. The third line 128 is drawn from the second-image spot 144 through the second-camera perspective center 142. The processor 150 selects intersection sets based at least in part on the nearness of intersection of the first line 124, the second line 126, and the third line 128.

The processor 150 may determine the nearness of intersection of the first line, the second line, and the third line based on any of a variety of criteria. For example, in an embodiment, the criterion for the nearness of intersection is based on a distance between a first 3D point and a second 3D point. In an embodiment, the first 3D point is found by performing a triangulation calculation using the first image point 134 and the second image point 144, with the baseline distance used in the triangulation calculation being the distance between the perspective centers 132 and 142. In the embodiment, the second 3D point is found by performing a triangulation calculation using the first image point 134 and the projector point 112, with the baseline distance used in the triangulation calculation being the distance between the perspective centers 134 and 116. If the three lines 124, 126, and 128 nearly intersect at the object point 122, then the calculation of the distance between the first 3D point and the second 3D point will result in a relatively small distance. On the other hand, a relatively large distance between the first 3D point and the second 3D would indicate that the points 112, 134, and 144 did not all correspond to the object point 122.

As another example, in an embodiment, the criterion for the nearness of the intersection is based on a maximum of closest-approach distances between each of the three pairs of lines. This situation is illustrated in FIG. 2D. A line of closest approach 125 is drawn between the lines 124 and 126. The line 125 is perpendicular to each of the lines 124, 126 and has a nearness-of-intersection length a. A line of closest approach 127 is drawn between the lines 126 and 128. The line 127 is perpendicular to each of the lines 126, 128 and has length b. A line of closest approach 129 is drawn between the lines 124 and 128. The line 129 is perpendicular to each of the lines 124, 128 and has length c. According to the criterion described in the embodiment above, the value to be considered is the maximum of a, b, and c. A relatively small maximum value would indicate that points 112, 134, and 144 have been correctly selected as corresponding to the illuminated object point 122. A relatively large maximum value would indicate that points 112, 134, and 144 were incorrectly selected as corresponding to the illuminated object point 122.

The processor 150 may use many other criteria to establish the nearness of intersection. For example, for the case in which the three lines were coplanar, a circle inscribed in a triangle formed from the intersecting lines would be expected to have a relatively small radius if the three points 112, 134, 144 corresponded to the object point 122. For the case in which the three lines were not coplanar, a sphere having tangent points contacting the three lines would be expected to have a relatively small radius.

It should be noted that the selecting of intersection sets based at least in part on a nearness of intersection of the first line, the second line, and the third line is not used in most other projector-camera methods based on triangulation. For example, for the case in which the projected points are coded points, which is to say, recognizable as corresponding when compared on projection and image planes, there is no need to determine a nearness of intersection of the projected and imaged elements. Likewise, when a sequential method is used, such as the sequential projection of phase-shifted sinusoidal patterns, there is no need to determine the nearness of intersection as the correspondence among projected and imaged points is determined based on a pixel-by-pixel comparison of phase determined based on sequential readings of optical power projected by the projector and received by the camera(s). The method element 190 includes storing 3D coordinates of the first collection of points.

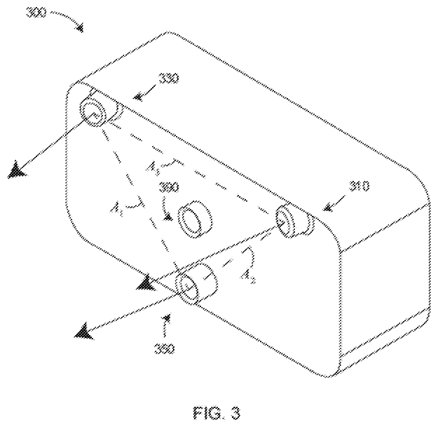

An alternative method that uses the intersection of epipolar lines on epipolar planes to establish correspondence among uncoded points projected in an uncoded pattern is described in Patent '455, referenced herein above. In an embodiment of the method described in Patent '455, a triangulation scanner places a projector and two cameras in a triangular pattern. An example of a triangulation scanner 300 having such a triangular pattern is shown in FIG. 3. The triangulation scanner 300 includes a projector 350, a first camera 310, and a second camera 330 arranged in a triangle having sides A1-A2-A3. In an embodiment, the triangulation scanner 300 may further include an additional camera 390 not used for triangulation but to assist in registration and colorization.

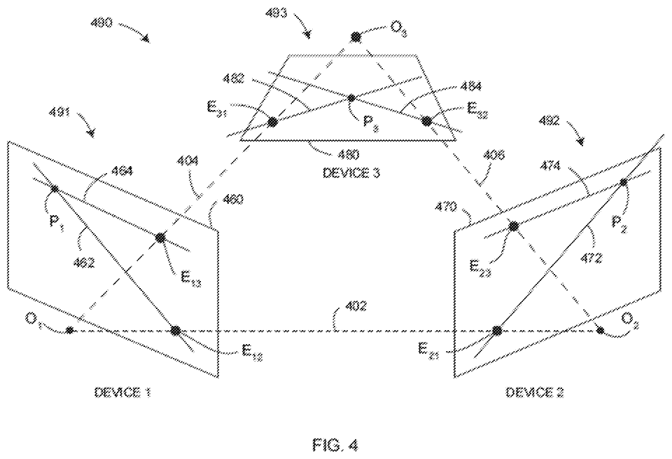

Referring now to FIG. 4 the epipolar relationships for a 3D imager (triangulation scanner) 490 correspond with 3D imager 300 of FIG. 3 in which two cameras and one projector are arranged in the shape of a triangle having sides 402, 404, 406. In general, the device 1, device 2, and device 3 may be any combination of pcameras and projectors as long as at least one of the devices is a camera. Each of the three devices 491, 492, 493 has a perspective center O₁, O₂, O₃, respectively, and a reference plane 460, 470, and 480, respectively. In FIG. 4, the reference planes 460, 470, 480 are epipolar planes corresponding to physical planes such as an image plane of a photosensitive array or a projector plane of a projector pattern generator surface but with the planes projected to mathematically equivalent positions opposite the perspective centers O₁, O₂, O₃. Each pair of devices has a pair of epipoles, which are points at which lines drawn between perspective centers intersect the epipolar planes. Device 1 and device 2 have epipoles E₁₂, E₂₁ on the planes 460, 470, respectively. Device 1 and device 3 have epipoles E₁₃, E₃₁, respectively on the planes 460, 480, respectively. Device 2 and device 3 have epipoles E₂₃, E₃₂ on the planes 470, 480, respectively. In other words, each reference plane includes two epipoles. The reference plane for device 1 includes epipoles E₁₂ and E₁₃. The reference plane for device 2 includes epipoles E₂₁ and E₂₃. The reference plane for device 3 includes epipoles E₃₁ and E₃₂.

In an embodiment, the device 3 is a projector 493, the device 1 is a first camera 491, and the device 2 is a second camera 492. Suppose that a projection point P₃, a first image point Pᵢ, and a second image point P₂ are obtained in a measurement. These results can be checked for consistency in the following way.

To check the consistency of the image point P₁, intersect the plane P₃-E₃₁-E₁₃ the reference plane 460 to obtain the epipolar line 464. Intersect the plane P₂-E₂₁-E₁₂ to obtain the epipolar line 462. If the image point P₁ has been determined consistently, the observed image point P₁ will lie on the intersection of the determined epipolar lines 462 and 464.

To check the consistency of the image point P2, intersect the plane P₃-E₃₂-E₂₃ with the reference plane 470 to obtain the epipolar line 474. Intersect the plane P₁-E₁₂-E₂₁ to obtain the epipolar line 472. If the image point P2 has been determined consistently, the observed image point P₂ will lie on the intersection of the determined epipolar lines 472 and 474.

To check the consistency of the projection point P3, intersect the plane P₂-E₂₃-E₃₂ with the reference plane 480 to obtain the epipolar line 484. Intersect the plane P₁-E₁₃-E₃₁ to obtain the epipolar line 482. If the projection point P₃ has been determined consistently, the projection point P₃ will lie on the intersection of the determined epipolar lines 482 and 484.

It should be appreciated that since the geometric configuration of device 1, device 2 and device 3 are known, when the projector 493 emits a point of light onto a point on an object that is imaged by cameras 491, 492, the 3D coordinates of the point in the frame of reference of the 3D imager 490 may be determined using triangulation methods.

Note that the approach described herein above with respect to FIG. 4 may not be used to determine 3D coordinates of a point lying on a plane that includes the optical axes of device 1, device 2, and device 3 since the epipolar lines are degenerate (fall on top of one another) in this case. In other words, in this case, intersection of epipolar lines is no longer obtained. Instead, in an embodiment of the present disclosure, determining self-consistency of the positions of an uncoded spot on the projection plane of the projector and the image planes of the first and second cameras is used to determine correspondence among uncoded spots, as described herein above in reference to FIGS. 2B, 2C, 2D, 2E.

FIGS. 5A, 5B, 5C, 5D, 5E are schematic illustrations of alternative embodiments of the projector 20. In FIG. 5A, a projector 500 includes a light source, mirror 504, and diffractive optical element (DOE) 506. The light source 502 may be a laser, a superluminescent diode, or a partially coherent LED, for example. The light source 502 emits a beam of light 510 that reflects off mirror 504 and passes through the DOE. In an embodiment, the DOE 506 produces an array of diverging and uniformly distributed light spots 512. In FIG. 5B, a projector 520 includes the light source 502, mirror 504, and DOE 506 as in FIG. 5A. However, in system 520 of FIG. 5B, the mirror 504 is attached to an actuator 522 that causes rotation 524 or some other motion (such as translation) in the mirror. In response to the rotation 524, the reflected beam off the mirror 504 is redirected or steered to a new position before reaching the DOE 506 and producing the collection of light spots 512. In system 530 of FIG. 5C, the actuator is applied to a mirror 532 that redirects the beam 512 into a beam 536. Other types of steering mechanisms such as those that employ mechanical, optical, or electro-optical mechanisms may alternatively be employed in the systems of FIGS. 5A, 5B, 5C. In other embodiments, the light passes first through the pattern generating element 506 and then through the mirror 504 or is directed towards the object space without a mirror 504.

In the system 540 of FIG. 5D, an electrical signal is provided by the electronics 544 to drive a projector pattern generator 542, which may be a pixel display such as a Liquid Crystal on Silicon (LCoS) display to serve as a pattern generator unit, for example. The light 545 from the LCoS display 542 is directed through the perspective center 547 from which it emerges as a diverging collection of uncoded spots 548. In system 550 of FIG. 5E, a source is light 552 may emit light that may be sent through or reflected off of a pattern generating unit 554. In an embodiment, the source of light 552 sends light to a digital micromirror device (DMD), which reflects the light 555 through a lens 556. In an embodiment, the light is directed through a perspective center 557 from which it emerges as a diverging collection of uncoded spots 558 in an uncoded pattern. In another embodiment, the source of light 562 passes through a slide 554 having an uncoded pattern of dots before passing through a lens 556 and proceeding as an uncoded pattern of light 558. In another embodiment, the light from the light source 552 passes through a lenslet array 554 before being redirected into the pattern 558. In this case, inclusion of the lens 556 is optional.

The actuators 522, 534, also referred to as beam steering mechanisms, may be any of several types such as a piezo actuator, a microelectromechanical system (MEMS) device, a magnetic coil, or a solid-state deflector.

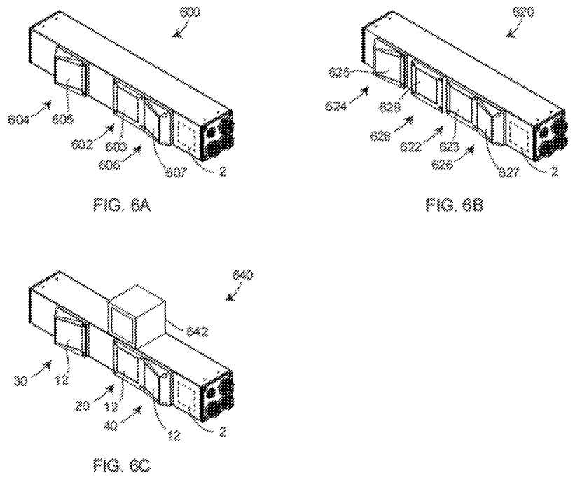

FIG. 6A is an isometric view of a triangulation scanner 600 that includes a single camera 602 and two projectors 604, 606, these having windows 603, 605, 607, respectively. In the system 600, the projected uncoded spots by the projectors 604, 606 are distinguished by the camera 602. This may be the result of a difference in a characteristic in the uncoded projected spots. For example, the spots projected by the projector 604 may be a different color than the spots projected by the projector 606 if the camera 602 is a color camera. In another embodiment, the triangulation scanner 600 and the object under test are stationary during a measurement, which enables images projected by the projectors 604, 606 to be collected sequentially by the camera 602. The methods of determining correspondence among uncoded spots and afterwards in determining 3D coordinates are the same as those described earlier in FIG. 2A-2D for the case of two cameras and one projector. In an embodiment, the system 600 includes a processor 2 that carries out computational tasks such as determining correspondence among uncoded spots in projected and image planes and in determining 3D coordinates of the projected spots.

FIG. 6B is an isometric view of a triangulation scanner 620 that includes a projector 622 and in addition includes three cameras: a first camera 624, a second camera 626, and a third camera 628. These aforementioned projector and cameras are covered by windows 623, 625, 627, 629, respectively. In the case of a triangulation scanner having three cameras and one projector, it is possible to determine the 3D coordinates of projected spots of uncoded light without knowing in advance the pattern of dots emitted from the projector. In this case, lines can be drawn from an uncoded spot on an object through the perspective center of each of the three cameras. The drawn lines may each intersect with an uncoded spot on each of the three cameras. Triangulation calculations can then be performed to determine the 3D coordinates of points on the object surface. In an embodiment, the system 620 includes the processor 2 that carries out operational methods such as verifying correspondence among uncoded spots in three image planes and in determining 3D coordinates of projected spots on the object.

FIG. 6C is an isometric view of a triangulation scanner 640 like that of FIG. 1A except that it further includes a camera 642, which is coupled to the triangulation scanner 640. In an embodiment, the camera 642 is a color camera that provides colorization to the captured 3D image. In a further embodiment, the camera 642 assists in registration when the camera 642 is moved—for example, when moved by an operator or by a robot.

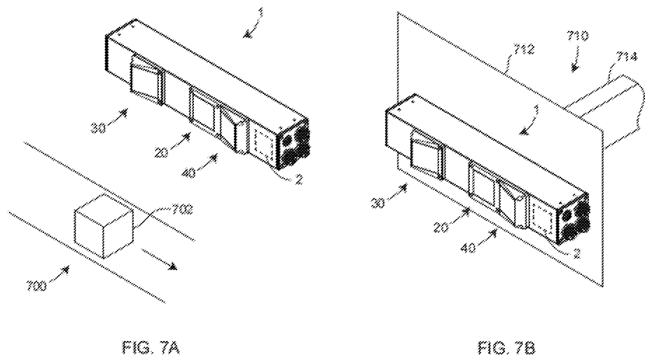

FIGS. 7A, 7B illustrate two different embodiments for using the triangulation scanner 1 in an automated environment. FIG. 7A illustrates an embodiment in which a scanner 1 is fixed in position and an object under test 702 is moved, such as on a conveyor belt 700 or other transport device. The scanner 1 obtains 3D coordinates for the object 702. In an embodiment, a processor, either internal or external to the scanner 1, further determines whether the object 702 meets its dimensional specifications. In some embodiments, the scanner 1 is fixed in place, such as in a factory or factory cell for example, and used to monitor activities. In one embodiment, the processor 2 monitors whether there is a probability of contact with humans from moving equipment in a factory environment and, in response, issue warnings, alarms, or cause equipment to stop moving.

FIG. 7B illustrates an embodiment in which a triangulation scanner 1 is attached to a robot end effector 710, which may include a mounting plate 712 and robot arm 714. The robot may be moved to measure dimensional characteristics of one or more objects under test. In further embodiments, the robot end effector is replaced by another type of moving structure. For example, the triangulation scanner 1 may be mounted on a moving portion of a machine tool.

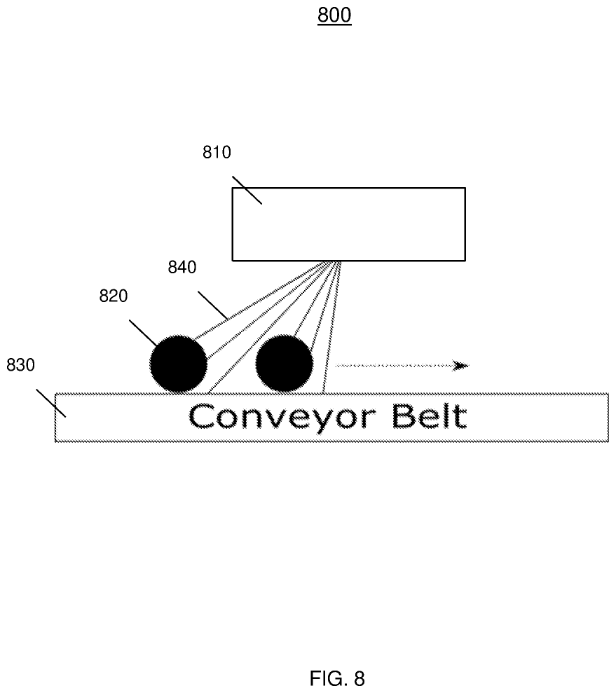

Now referring to FIG. 8, a system 800 similar to the system 700 shown in FIG. 7A provides an example of the scanner operating as a light curtain in accordance with one or more embodiments of the disclosure. The scanner 810 is configured to track the movement of the object 820 along the conveyor 830. As shown, the scanner 810 projects a plurality of laser beams 840 towards the conveyor 830. The scanner 810 is configured to generate a distance profile using a first beam of a beam array is shown. The distance profile includes distance measurements to the object that is plotted against time. In other embodiments, the object may be a motorized device and is capable of moving independently of the conveyor 830. In one or more embodiments of the disclosure, the system 800 and/or processor is configured to record time data which can correspond to the time at which the points of the distance profile are obtained.

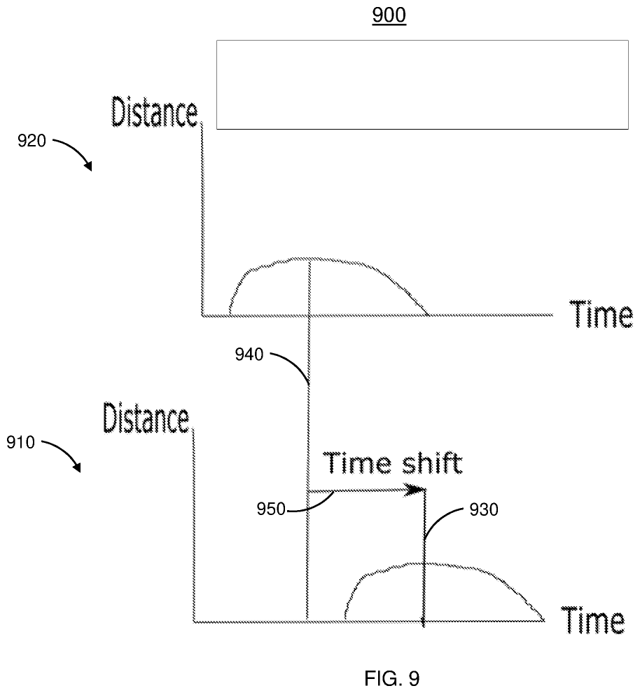

Now referring to FIG. 9, an example of distance profiles 910, 920 that is generated by the system 800 is shown. The distance profiles 910, 920 include a graph where the x-axis represents the time that has elapsed and the y-axis represents the distance the object is from the scanner 810. A first beam detects the object 820 as it traverses across its FOV. Similarly, the second beam detects the object 820 as it traverses its FOV. Subsequently, the first and second distance profiles can be compared to match similar points in each of the profile to track the speed at which the object is traveling.

For example, the peak of the distance profile 920 for the first beam is shown at position 930 and the peak for the distance profile 920 for the second beam is shown at position 940. By comparing the two profiles, a time-shift 950 between the first distance profile 910 and the second distance profile 920 can be determined. In one or more embodiments, a cross-correlation analysis can be performed between the distance profiles 910, 920 to determine the time-shift 950. After the time-shift 950 has been determined, the velocity can be calculated using the distance traveled between the first and second beams and the time-shift 950. That is, the measured points at the peak or other identifiable points of the beams are used. The speed of the object is assumed to be constant over at least a unit of time to generate the distance profile.

In one or more embodiments of the disclosure, an object 820 can be traveling on a conveyor and can be tracked by the system 800. The conveyor 830 can be calibrated with the system 800 to improve the measurements between the distance profiles of each object. In other embodiments, the position information and timestamp information can be used calculate or estimate the velocity information. For example, a device that moves the object can provide information to measure the speed of the device, conveyor belt, mover, etc. The device can include a roll or other components that can be associated with a position and time stamp to determine the velocity.

In one or more embodiments of the disclosure, a processor coupled to the scanner 810 is configured to perform a filtering operation to remove unrelated distance profile information. For example, the distance profile information can be used to detect the direction of the moving object and beams that are indicating movement within the beams in the opposite direction can be filtered out from further processing.

A processor coupled to the scanner 810 can be configured to assign beams that provide a distance profile that are similar to one another that are determined to be within a tolerance or margin of error of each other. The beams that are outside of the tolerance or margin of error can be filtered out of the set of beams and the remaining beams that provide similar distance profiles can be assigned to the same object. The outlier data can be filtered using known techniques such as linear regression.

In one or more embodiments of the disclosure, the beam pairs from the beams that were assigned to the object can be selected for time-shift analysis. Several beam pairs can be analyzed to obtain a more accurate velocity estimation for the object. The analysis of multiple beams pairs may be desired. In some scenarios, different beams may not hit the same part of the object because the beams may not be parallel. In addition, the movement direction of the object may not necessarily be parallel to the beam pattern. In some embodiments of the disclosure, the average of the plurality of velocity calculation can be performed to obtain a representative velocity of the object.

In some embodiments, a configurable threshold number of beam pairs may be analyzed prior to providing the velocity estimation. In other embodiments, a statistical analysis can be performed to generate a confidence value for the velocity estimation, and the velocity estimation may not be provided until a configurable confidence value is achieved.

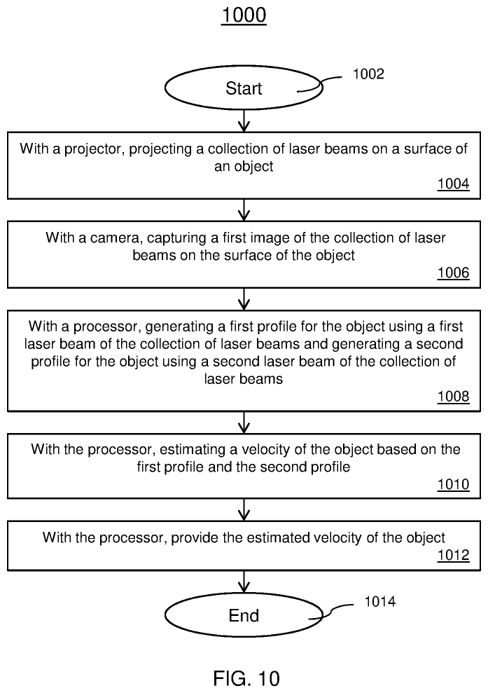

Now referring FIG. 10, a flowchart of a method 1000 for performing tracking of an object integrated within a 3D scanner in accordance with one or more embodiments of the disclosure is shown. The method 1000 begins at block 1002 and proceeds to block 1004 which provides a projector having a projector optical axis on a first plane, the projector operable to project a collection of laser beams on a surface of an object. In one or more embodiments of the disclosure, the collection of laser beams operate as a light barrier or light curtain and can be used to estimate the velocity of a moving object passing through the laser beams. At block 1006 a first camera having a first-camera optical axis on the first plane captures a first image of the collection of laser beams on the surface of the object.

Block 1008 a processor is configured to generate a first profile for the object using a first laser beam of the collection of laser beams and generate a second profile for the object using a second laser beam of the collection of laser beams. The distance to the object and time information is provided on the distance profile.

Block 1010 estimates the velocity of the object based on the first profile and the second profile. In one or more embodiments of the disclosure, a shift analysis can be performed to analyze the first and second the distance profiles. For example, the analysis can include calculating the sum of absolute differences or using feature-based methods or any other version of cross-correlation calculations. In addition, the time-shift can be calculated by performing a cross-correlation analysis of the distance profiles where the correlation of the time shifted signals is the highest for the time-shifted signals.

Block 1012 provides the estimated velocity. The velocity information can be provided in a numerical or graphical format on a display. In addition, the estimated velocity can be transmitted to another internal/external device or system over a network. It should be understood the method 1000 described herein is not intended to be limited by the steps shown in FIG. 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A device for measuring three-dimensional (3D) coordinates, comprising:
a projector having a projector optical axis on a first plane, the projector operable to project a collection of laser beams on a surface of an object;
a first camera having a first-camera optical axis on the first plane, the first camera operable to capture a first image of the collection of laser beams on the surface of the object;
one or more processors, wherein the one or more processors are operable to:
generate a first distance profile for the object using a first laser beam of the collection of laser beams and generate a second distance profile for the object using a second laser beam of the collection of laser beams;
estimate the velocity of the object based on the first distance profile and the second distance profile; and
provide the estimated velocity.

2. The system of claim 1, wherein the one or more processors are further operable to perform a shift analysis using the first distance profile and the second distance profile.

3. The system of claim 1, wherein the one or more processors are further operable to determine a time-shift between the first distance profile and the second distance profile by performing a comparison of the first distance profile and the second distance profile.

4. The system of claim 1, wherein the one or more processors are operable to filter laser beams of the collection of laser beams; and
assign laser beams of the collection of laser beams to the object.

5. The system of claim 1, wherein the filtering of the laser beams is based on at least one of a direction or a similarity in the generated profiles laser beams of the collection of laser beams.

6. The system of claim 1, wherein the one or more processors are operable to determine a set of time-shifts for the object using a plurality of laser beam pairs of the collection of laser beams.

7. The system of claim 6, wherein estimating the velocity comprising averaging the set of time-shifts for the object.

8. The system of claim 1, wherein generating a profile comprising obtaining 3D points of the object, calculating a distance of the 3D points between each laser beam, and using the distance and timing information to estimate the velocity of the object.

9. The system of claim 1, wherein the one or more processors are further operable to receive input velocity information associated with a device that moves the object; and
compare the estimated velocity of the object to the input velocity information.

10. The system of claim 9, wherein the input velocity information is determined from at least one of time stamp information or position information of the device that moves the object, wherein the device is at least one of a mover or a conveyor belt.

11. A method comprising:
projecting, with a projector, a collection of laser beams on a surface of an object;
capturing, with a camera, a first image of the collection of laser beams on the surface of the object;
generating a first distance profile for the object using a first laser beam of the collection of laser beams and generating a second distance profile for the object using a second laser beam of the collection of laser beams;
estimating, using one or more processors, a velocity of the object based at least in part on the first distance profile and the second distance profile;
providing, using the one or more processors, the estimated velocity of the object.

12. The method of claim 11, further comprising performing a shift analysis using the first distance profile and the second distance profile.

13. The method of claim 11, furthering comprising determining a time-shift between the first distance profile and the second distance profile by performing a comparison of the first profile and the second profile.

14. The method of claim 11, further comprising filtering laser beams of the collection of laser beams; and
assigning laser beams of the collection of laser beams to the object.

15. The method of claim 11, wherein the filtering of the laser beams is based on at least one of a direction or a similarity in the generated distance profiles laser beams of the collection of laser beams.

16. The method of claim 10, further comprising determining a set of time-shifts for the object using a plurality of laser beam pairs of the collection of laser beams.

17. The method of claim 16, wherein estimating the velocity comprises averaging the set of time-shifts for the object using the plurality of laser beam pairs.

18. The method of claim 11, wherein generating a distance profile comprises obtaining 3D points of the object, calculating a distance of the 3D points between each laser beam, and using the distance and timing information to estimate the velocity of the object.

19. The method of claim 11, further comprising receiving input information associated with a device that moves the object, wherein the input information includes at least one of velocity information, time stamp information, or position information of the device that moves the object; and
comparing the estimated velocity of the object to the input information.

20. The method of claim 11, further comprising calibrating a conveyor system moving the object to a configured velocity.
